(19) United States
(12) Patent Application Publication
(10) Pub. No.: US 2001/0029458 A1
(43) Pub. Date: Oct. 11, 2001

(54) Device for electrical article search and supply services and method for electrical article search and supply services

(76) Inventors: Koichiro Tsuda, Tokyo (JP); Yasuyuki Sato, Kanagawa (JP)

Correspondence Address: SUGHRUE, MION, ZINN, MACPEAK & SEAS, 2100 Pennsylvania Avenue, N.W., Washington, DC, 20037, US

(21) Appl. No.: 09/810,556

(22) Filed: Mar. 19, 2001

(30) Foreign Application Priority Data
Mar. 24, 2000 (JP) 2000-084214

(51) Int. Cl. G06F 17/60

(52) U.S. Cl. 705/1

(57) ABSTRACT

A device for electronic article search and supply services according to the present invention includes meta-data described by definitions that each publisher providing the electronic article defines differently, a meta-data loading unit for absorbing the different definitions and loading each of the meta-data, a database established by storing data loaded by the meta-data loading unit, a search unit for searching through the database, a link information display unit for displaying link information to the electronic article indicated by the meta-data, and an access unit for accessing to the indicated electronic article.

### BACKGROUND OF THE INVENTION

1. Field of the Invention

The present invention relates to electronic article search and supply services whereby a contracted subscriber can obtain information on an electronic article over a computer network, particularly to a device for electronic article search and supply services whereby definitions which are different for each publisher can be absorbed and billing can be performed based on a subscription contract of the electronic article.

2. Description of the Related Art

Due to the spread of information electronic information and Internet information supply services, a subscriber can search an electronic article over Internet in order to obtain information at home.

The electronic retrieval and supply services having such a construction allows content searches in order to obtain information without going to libraries and/or bookstores.

However, in the conventional electronic article search and supply services, a subscriber has to make a contract with each publisher separately and access to a database of each publisher over a computer network depending on a demanded article, for example. Then, the subscriber inputs a different ID/password for each publisher in order to enter services. Further, the subscriber searches throughout an electronic article in which a searching article is stored and then accesses an original article through a search interface which is also different for each publisher.

Thus, the subscriber has to be always conscious about differences of data description and searching methods for each of publishers. Further, the subscriber has to select a database system of each publisher to be connected depending on a searched article. This is not only troublesome for subscribers because he/she is required to have extra information other than information for obtaining the article, but also it may cause oversights of searching articles.

### SUMMARY OF THE INVENTION

The present invention was made in order to overcome the above-described problems. Accordingly, it is an object of the present invention to provide a device for electronic article search and supply services, which can absorb definitions which are different for each of publishers and perform authorization of an access right instead of each publisher and billing based on subscribing contract of an electronic article.

A device for electronic article search and supply services, to which a subscriber having a subscription contract accesses over a computer network in order to obtain information on an electronic article, according to one aspect of the present invention includes meta-data described by definitions that each publisher providing the electronic article defines differently, a meta-data loading unit for absorbing the different definitions and loading each of the meta-data, a database established by storing data loaded by the meta-data loading unit, a search unit for searching through the database, a link information display unit for displaying link information to the electronic article indicated by the meta-data, and an access unit for accessing to the indicated electronic article.

In this case, the meta-data is preferably an article bibliography or an article subscriber of the electronic article and link information indicating a place where its original article is placed electronically.

The device for electronic article search and supply services may further include a subscription master in which subscriber's additional information is stored. In this case, the search unit may include an access right authorization unit for authorizing a subscriber's access right based on information from the subscription master.

The search unit may further include a billing unit for billing a subscriber based on information from the subscription master when a search is executed.

The meta-data may be described by using the Generalized Markup Language or Extensible Mark-up Language.

In this case, the meta-data may be provided by each of the publishers over the computer network or through an auxiliary memory medium.

A method for electronic article search and supply services, to which a subscriber having a subscription contract accesses over a computer network in order to obtain information on an electronic article, according to another aspect of the present invention includes the steps of loading each of the meta-data described by definitions that each publisher providing the electronic article defines differently by absorbing the different definitions, storing data loaded by the meta-data loading step in a database, providing search unit for searching through the database, and obtaining the electronic article based on link information indicated by the meta-data.

In this case, the meta-data may be an article bibliography or an article subscriber of the electronic article and link information indicating a place where its original article is placed electronically. A method for electronic article search and supply services may further includes the step of storing subscriber's additional information in a subscription master. Preferably, the search unit includes an access right authorization unit for authorizing a subscriber's access right based on information from the subscription master.

The search unit may further include a billing unit for billing a subscriber based on information from the subscription master when a search is executed.

The meta-data may be described by using the Generalized Markup Language or Extensible Mark-up Language.

The meta-data is preferably provided by each of the publishers over the computer network or through an auxiliary memory medium.

### BRIEF DESCRIPTION OF THE DRAWINGS

FIG. 1 is a system diagram of a network including a device for electronic article search and supply services according to the present invention;

FIG. 2 is a block diagram showing a detail of the device for electronic article search and supply services according to the present invention;

FIG. 3 is a schematic diagram for describing differences as a partial information of meta-data;

FIG. 4 is a schematic diagram for describing differences as additional information of meta-data;

FIG. 5 is a schematic diagram for describing differences as quality information of meta-data;

FIG. 6 is a schematic diagram for describing differences as identification of meta-data; and

FIG. 7 is a flowchart for showing an operation of the device for electronic article search and supply service according to the present invention when the device is used.

### DESCRIPTION OF THE PREFERRED EMBODIMENTS

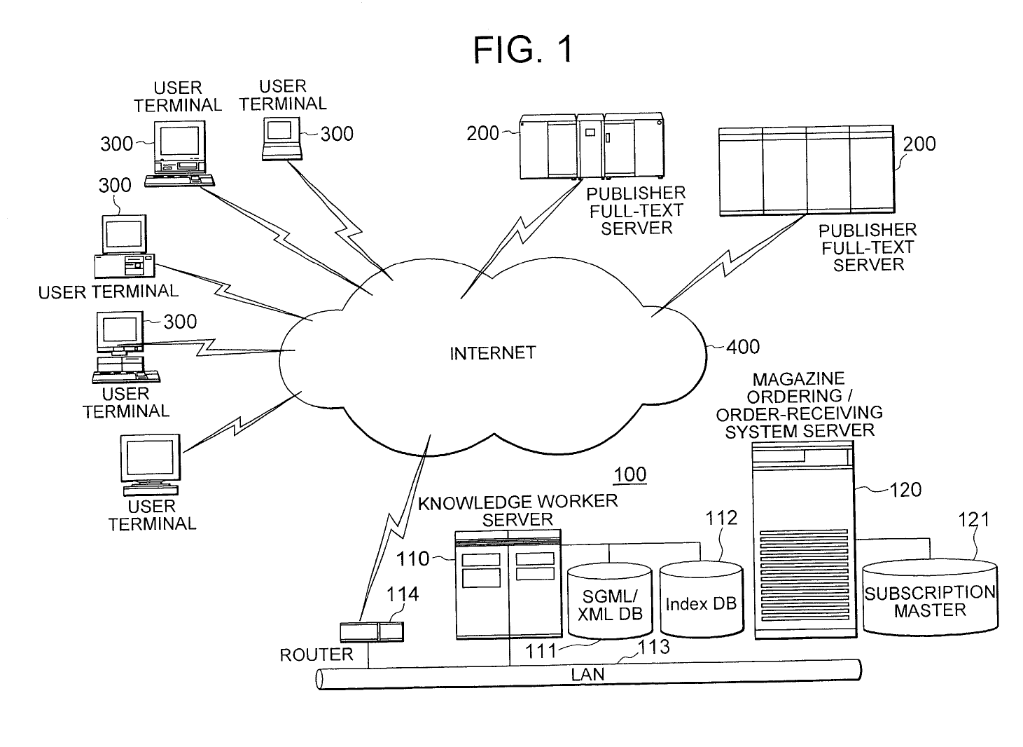

FIG. 1 is a system diagram of a network including a device for electronic article supply services according to the present invention. FIG. 1 includes an electronic article search and supply service device 100 which is located in a company for providing electronic article search and supply services, for example.

The electronic article search and supply service device 100 has a knowledge worker server 110, an SGML/XML database 111, and an index database 112. The SGML/XML database 111 and the index database 112 are connected to the knowledge worker server 110.

Further, the electronic article search and supply service device 100 includes a magazine ordering/order-receiving system server 120 and a subscription master 121 connected thereto.

The knowledge worker server 110 and the magazine ordering/order-receiving system server 120 are connected over a computer network 113, which is a Local Area Network (LAN), for example. They can reference to data mutually. Further, knowledge worker server 110 and the magazine ordering/order-receiving system server can be connected to Internet 400 as a computer network through a router 114 connected to a computer network 113.

On the other hand, a publisher full-text server 200 in which full-text information of many electronic articles is located for every publisher and can be connected to the Internet 400.

Furthermore, a user terminal 300 used by a subscriber is placed at a site of each subscriber and also can be connected to the Internet 400.

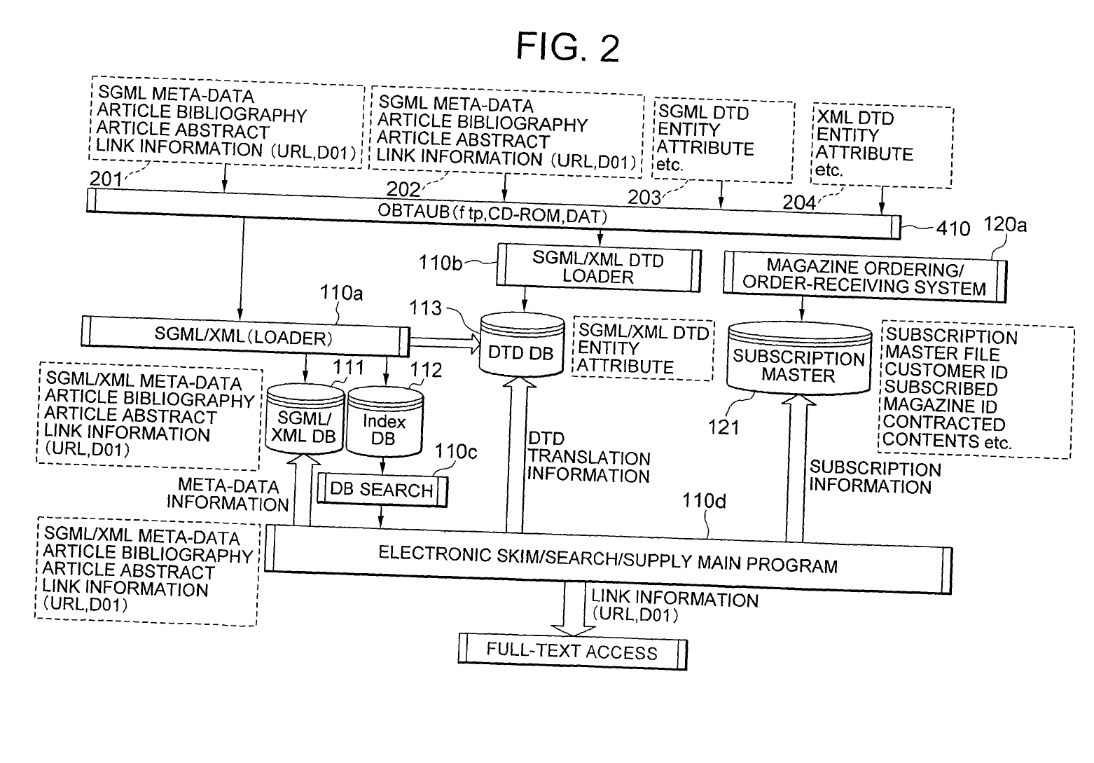

FIG. 2 is a block diagram for showing a detail of a device for electronic article search and supply services according to the present invention. In this embodiment, each publisher describes meta-data by using Standard Generalized Markup Language (SGML) or Extensible Markup Language (XML) which is extended therefrom. Such SGML/XML documents uses a document definition called Document Type Definition (DTD) in order to define described contents of sentences for being available to third parties.

In FIG. 2, an SGML meta-data 201, an XML meta-data 202, an SGML document definition body 203, and an XML document definition body 204 are stored in a publisher full-text server 200 provided for each publisher.

The SGML meta-data 201 and the XML meta-data 202 are described by the above-described SGML or XML, and article bibliographies or article abstracts of electronic articles, link information as an electronic place where both and original articles exist (URL: Uniform Resource Locator, or DOI: Digital Object Identifier), identification information inherent to a publisher and so on are recorded therein.

On the other hand the SGML document definition body 203 and the XML definition body 204 describes the document definition called DTD and entities, attributes and so on are recorded therein.

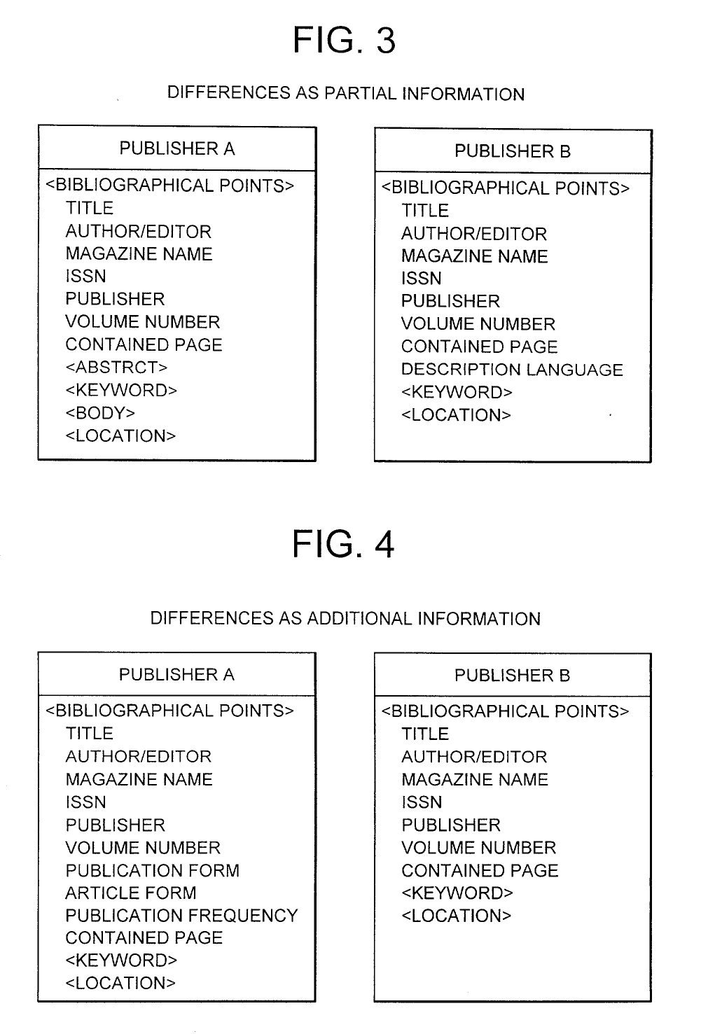

The SGML meta-data 201 and the XML meta-data 202 are described by definitions which are different for every publisher depending on convenience of each publisher. FIGS. 3 to 6 are schematic diagrams for describes different definitions for the SGML meta-data 201 and the XML meta-data 202.

FIG. 3 is a schematic diagram for describing differences as partial information of meta-data. In each publisher, meta-data is not only produced as a single derivative but also created as an original script of a booklet type publication or a publication on an electronic media in many cases. Therefore, some publisher call a bibliography or an abstract including information regarding an existing place so-called header of full text of an article as meta-data. Thus, for example, Publisher A has “abstract” information and “body” information while Publisher B does not.

Further, FIG. 4 is a schematic diagram for describing differences as additional information of meta-data. Most meta-data are created as additional information for booklet-type publications. In such a case, composition elements of the meta-data is defined by publication form elements of the booklet-type publications. For example, in information in bibliographical points, Publisher A includes headings, “publication form”, “article form”, and “publishing frequency”, while Publisher B does not.

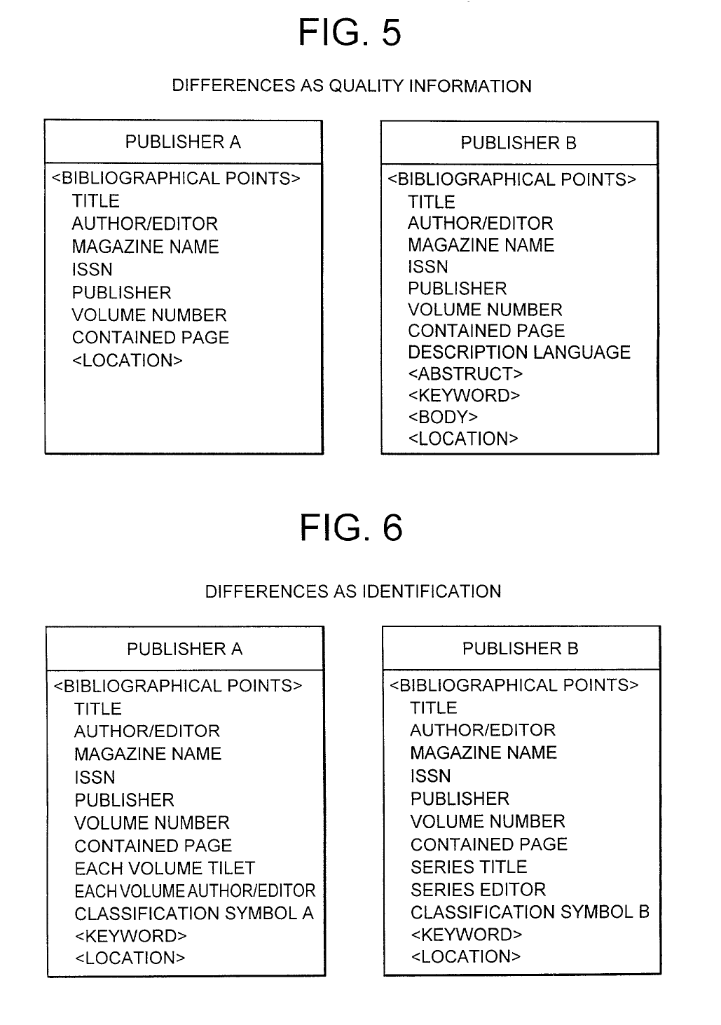

Further, FIG. 5 is a schematic diagram for describing differences as quality information of meta-data. In general, many times and costs are needed for creating meta-data. Thus, levels for which each publisher can invest in meta-data differ naturally. As a result, differences in density on quality occur in contents of meta-data. For example, in information in the bibliographical headings, Publisher A does not have “description language”, “abstract”, and information on “keyword” and “body”.

Furthermore, FIG. 6 is a schematic diagram for describing differences as identification of meta-data. In the library science, a technology for describing entity information described in a medium as mapped information has been discussed for long time as a catalog creating technology, which results in some international standard technologies. However, in reality, many differences are caused by a degree of recognition on their relationships. Thus, even during creation of meta-data, the decree of recognition of relationship between their entities and mappings depends on an intention of a creator. Also, those technology is still being established as standard technologies. Therefore, even if it is meta-data relating to a same article, the meta-data may differ depending on the degree of recognition of the creator of the meta-data. For example, Publisher A uses “each volume title” and “each volume author/editor” while Publisher B uses “series title” and “series editor”.

In this way, the SGML meta-data 201, the XML meta-data 202, and the SGML document definition body 203 and the XML document definition body 204, every publisher are transferred from every publisher periodically by using a protocol such as File Transfer Protocol (FTP). Alternatively, they are provided on a mobile medium such as CD-ROM (Compact Disc Read-Only Memory) and Digital Audio Tape recorder (DAT) periodically from every publisher.

The knowledge worker server 110 loads the SGML meta-data 201 and the XML meta-data 202 by using an SGML/XML loader 110a as a meta-data load unit which is one of programs stored therein, in order to store them in an SGML/XML database 111 which is a single database. At the same time, an index database 112 is established as a collection of index words for specifying meta-data.

Further, data of the SGML document definition body 203 and the XML document definition body 204 are loaded by using an SGML/XML DTD loader 110b as a meta-data load unit in the same manner in order to store them in a DTD database 113.

Since the SGML meta-data 201 and the XML meta-data 202 are described by SGML or XML, they are loaded while different definitions thereof are absorbed by the SGML/XML loader 110a even when they are described by a definition each different for every publisher.

That is, when the SGML/XML loader 110a establishes the above-described index database 112, it refers to the SGML document definition body 203 and the XML document definition body 204 in order to parse them for uniformity of a search method, which is reflected in the collection of index words.

On the other hand, the magazine ordering/order receiving system server 120 collects information such as customer IDs, subscribed magazine IDs, and contracted contents through a magazine ordering/order-receiving system 120a which is one of programs stored therein in order to store them in a subscription master 121.

Further, the knowledge worker server 110 stores an electronic article search and supply main program 110d as a search unit. The electronic article search and supply main program 110d refers to the SGML/XML database 111, the index database 112, the DTD database 113, and the subscription master 121 properly in order to supply required information to subscribers.

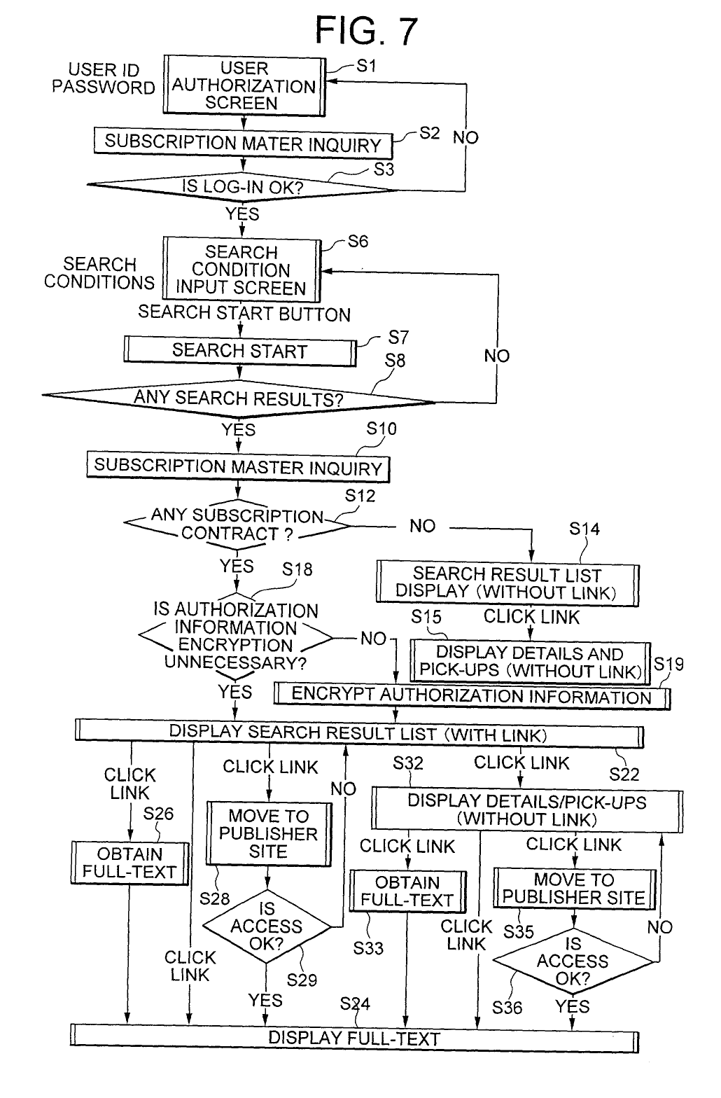

FIG. 7 is a flowchart for showing an operation of a device for electronic article search and supply services of the present invention when the device is used. When a subscriber accesses to the knowledge worker server 110, the electronic article search and supply main program 110d being used as the above-described search unit displays a user authorization screen (step S1). Then, once the subscriber inputs his/her ID on the screen (step S2), the ID is inquired based on the subscription master 121. If the authorization is determined, the permission for logging-in is given to the subscriber (step S3).

After that, when the subscriber enters into the system through the logging-in, the electronic article search and supply main program 110d displays a search condition input screen next (step S6). Then, when the subscriber inputs search conditions to the screen, the index database 112 is referred based on the search condition through the database search program 110c in order to search a bibliography or an abstract of an electronic article from meta-data stored in the SGML/XML database 111 (step S7). As a result of the search, if the bibliography or the abstract to the electronic article which satisfies the search condition, the electronic article search and supply main program 110d goes to a next step. If nothing is found, the electronic article search and supply main program 110d goes back to the step S6 and displays the search condition input screen again (step S8).

In this way, when the bibliography or the abstract of the electronic article satisfying the search conditions is found, the electronic article search and supply main program 110d inquires of the subscription master 121 (step S10) in order to determine whether his/her subscription contract exists or not based on the information from the subscription master 121 (step S12). If his/her subscription contract does not exist, the electronic article search and supply main program 110d displays a search result list (without link) (step S14). If a link is clicked on the screen, the electronic article search and supply main program 110d displays details and pick-ups (step S15) and goes back to the step S6).

On the other hand, if his/her subscription contract exists, the subscription master 121 is inquired and the subscriber is billed based on the recorded subscription contract. After that, it is determined whether encryption is necessary or not (step S18). If it is necessary, encryption is performed on the authorization information (step S19). Then, a search result list (without link) is displayed (step S22). Here, the electronic article search and supply main program 110d refers to the DTD database 113 and parses to obtain the same display format.

Further, in the step S22, the electronic article search and supply main program 110d refers to the subscription master 121 in order to determine whether an article which is an entity of meta-data specified by the search can be obtained or not. If the subscriber has a contract permitting to obtain the article, the electronic article search and supply main program 110d permits the subscriber to obtain the article by using link information. On the other hand, if the subscriber does not have the contract, the electronic article search and supply main program 110d provides meta-data only and inhibit the subscriber to obtain the article.

Operations after the above-described step vary depending of manipulations by the subscriber. That is, when the subscriber clicks a link simply, full-text (electronic article) can be displayed (step S24) thereby. On the other hand, the full-text (electronic article) can be obtained and then displayed from the publisher full-text server 200 by the knowledge worker server 110 instead of the subscriber (step S26).

Further, the subscriber may click a link in order to move to a publisher site (step S28). If his/her access is allowed in the site (step 29), the full-text (electronic article) can be displayed here.

Further, after details/pick-ups are displayed (step S32), the subscriber can obtain the full-text (electronic article) (step S33) or move to the publisher site (step S35, S36).

When the full text (electronic article) is obtained or displayed, the electronic article search and supply main program 110d may inquire of the subscription master 121 and bills the subscriber based on his/her subscription contract here.

In this way, the electronic article search and supply main program 110d includes a search unit, an access right authorization unit for authorizing a subscribers access right based on information from the subscription master 121, a billing unit for billing a subscriber based on information from the subscription master 121 when a search is done, a link information display unit for displaying link information to an electronic article indicated by meta-data, and an access unit for accessing to the indicated electronic article.

The electronic article search and supply service device having the above-described construction can absorb definitions different for every publisher. Further, it authorizes an access right instead of each publisher. Still further, it can bills a subscriber according to his/her subscription contract for an electronic article. Furthermore, it can absorb differences in methods for accessing an original article.

In this embodiment, as a meta-data load means for loading meta-data described by definitions that every publisher defines differently as well as absorbing the different definitions, the SGML/XML loader 110a and the SGML/XML DTD loader 110b are used. However, it is not limited to those loaders, and the same effect can be obtained by any loader if it can absorb the different definitions for loading.

A device for electronic article search and supply services, to which a subscriber having a subscription contract accesses over a computer network in order to obtain information on an electronic article, according to one aspect of the present invention includes meta-data described by definitions that each publisher providing the electronic article defines differently, a meta-data loading unit for absorbing the different definitions and loading each of the meta-data, a database established by storing data loaded by the meta-data loading unit, a search unit for searching through the database, a link information display unit for displaying link information to the electronic article indicated by the meta-data, and an access unit for accessing to the indicated electronic article. Thus, it can absorb definitions different for every publisher. Further, a single database system is established by merging meta-data of each publisher in order to provide a merged search method. Therefore, it can be a highly convenient device for subscribers.

In this case, the meta-data is preferably an article bibliography or an article subscriber of the electronic article and link information indicating a place where its original article is placed electronically. Thus, link information permits an access to an electronic place where an electronic article exists and further allows movement to the electronic place, which increases usage values.

The device for electronic article search and supply services may further include a subscription master in which subscriber's additional information is stored. In this case, the search unit may include an access right authorization unit for authorizing a subscriber's access right based on information from the subscription master. Thus, it can authorize the access right instead of each publisher. the subscriber can uses services by using one ID/password, which improves convenience.

The search unit may further include a billing unit for billing a subscriber based on information from the subscription master when a search is executed. Thus, billing can be performed instead of each publisher, which reduces the complexity of processing.

The meta-data may be described by using the Generalized Markup Language or Extensible Mark-up Language. Thus, by using the generalized language, a system can be constructed and extended easily, which may reduce costs.

In this case, the meta-data may be provided by each of the publishers over the computer network or through an auxiliary memory medium. Thus, mew meta-data can be supplied easily, which may reduce costs. Further, the meta-data can be supplied immediately and latest information is always provided to subscribers, which increases the usage values.

A method for electronic article search and supply services, to which a subscriber having a subscription contract accesses over a computer network in order to obtain information on an electronic article, according to another aspect of the present invention includes the steps of loading each of the meta-data described by definitions that each publisher providing the electronic article defines differently by absorbing the different definitions, storing data loaded by the meta-data loading step in a database, providing search unit for searching through the database, and obtaining the electronic article based on link information indicated by the meta-data.

In this case, the meta-data may be an article bibliography or an article subscriber of the electronic article and link information indicating a place where its original article is placed electronically. A method for electronic article search and supply services may further includes the step of storing subscriber's additional information in a subscription master. Preferably, the search unit includes an access right authorization unit for authorizing a subscriber's access right based on information from the subscription master.

The search unit may further include a billing unit for billing a subscriber based on information from the subscription master when a search is executed.

The meta-data may be described by using the Generalized Markup Language or Extensible Mark-up Language.

The meta-data is preferably provided by each of the publishers over the computer network or through an auxiliary memory medium. Thus, it can absorb definitions different for every publisher. Further, a single database system is established by merging meta-data of each publisher in order to provide a merged search method. Therefore, it can be a highly convenient device for subscribers.

What is claimed is:

1. A device for electronic article search and supply services to which a subscriber having a subscription contract accesses over a computer network in order to obtain information on an electronic article, comprising:
meta-data described by definitions that each publisher providing said electronic article defines differently;
meta-data loading means for absorbing said different definitions and loading each of said meta-data;
a database established by storing data loaded by said meta-data loading means;
search means for searching through said database;
link information display means for displaying link information to said electronic article indicated by said meta-data; and
access means for accessing to said indicated electronic article.

2. A device for electronic article search and supply services according to claim 1 wherein said meta-data is an article bibliography or an article subscriber of said electronic article and link information indicating a place where its original article is placed electronically.

3. A device for electronic article search and supply services according to claim 1, further comprising a subscription master in which subscriber's additional information is stored wherein said search means comprises access right authorization means for authorizing a subscriber's access right based on information from said subscription master.

4. A device for electronic article search and supply services according to claim 3, said search means further comprising billing means for billing a subscriber based on information from said subscription master when a search is executed.

5. A device for electronic article search and supply services according to claim 1 wherein said meta-data is described by using the Generalized Markup Language or Extensible Mark-up Language.

6. A device for electronic article search and supply services according to claim 1 wherein said meta-data is provided by each of said publishers over said computer network or through an auxiliary memory medium.

7. A method for electronic article search and supply services to which a subscriber having a subscription contract accesses over a computer network in order to obtain information on an electronic article, comprising the steps of:
loading each of said meta-data described by definitions that each publisher providing said electronic article defines differently by absorbing said different definitions;
storing data loaded by said meta-data loading step in a database;
providing search means for searching through said database; and
obtaining said electronic article based on link information indicated by said meta-data.

8. A method for electronic article search and supply services according to claim 7 wherein said meta-data is an article bibliography or an article subscriber of said electronic article and link information indicating a place where its original article is placed electronically.

9. A method for electronic article search and supply services according to claim 7, further comprising the step of storing subscriber's additional information in a subscription master, wherein said search means comprises access right authorization means for authorizing a subscriber's access right based on information from said subscription master.

10. A method for electronic article search and supply services according to claim 9, said search means further comprising billing means for billing a subscriber based on information from said subscription master when a search is executed.

11. A method for electronic article search and supply services according to claim 7 wherein said meta-data is described by using the Generalized Markup Language or Extensible Mark-up Language.

12. A method for electronic article search and supply services according to claim 7 wherein said meta-data is provided by each of said publishers over said computer network or through an auxiliary memory medium.
